(19) United States
(12) Patent Application Publication
(10) Pub. No.: US 2012/0262578 A1
(43) Pub. Date: Oct. 18, 2012

(54) VEHICULAR AROUND-VIEW DRIVING MONITOR AND RECORDER

(75) Inventors: Mao Huai WENG, New Taipei City (TW); Hsia Pin Liao, New Taipei City (TW)

(73) Assignee: ACARD TECHNOLOGY CORP., New Taipei City (TW)

(21) Appl. No.: 13/088,758

(22) Filed: Apr. 18, 2011

(51) Int. Cl. H04N 7/18

(52) U.S. Cl. 348/148; 348/E07.085

(57) ABSTRACT

A vehicular around-view driving monitor and recorder includes a plurality of wide-angle cameras, a real-time image monitoring and recording/playing unit, a visual image operation system, and a display device, which enables a real-time monitoring and recording of around-view raw image data shot by wide-angle cameras. The present invention also performs a real-time visual processing which includes data correction toward the twisted raw images, image overlapping and a combination of algorithmic operation via the visual image operation system to convert those raw images shot from cameras into round-view ones shown on the display which fits the driver's visual practice and driving habit, and provides better safety, correct and convenient visual assistance and driving judgment. Alternatively, the processed images could be displayed in a bird-view mode to have an additional circumferential reference. Therefore, it is applicable to drivers' visual assistance and the recovery of traffic evidence of various types of vehicles.

### BACKGROUND OF THE INVENTION

1. Field of the Invention

The present invention is generally relates to a vehicular around-view driving monitor and recorder, and more particularly to a configuration that comprises a plurality of wide-angle cameras, a real-time image monitoring and recording/playing unit, a visual image operation system, and a display device, which enables a real-time processing and algorithmic operation on around-view raw image data shot by wide-angle cameras to provide the drivers with better safety, correct and convenient visual assistance and driving judgment. Alternatively, the processed images could be selected to display in a bird-view mode to let drivers have an additional circumferential reference. Besides, the original images of surrounding environment and driving data of the time point whenever a traffic accident occurs can be genuinely stored and replayed without any illegal alteration and/or modification. Therefore, the present invention is applicable to drivers' visual assistance and the recovery of traffic evidence of various types of vehicles.

2. Description of Related Art

Due to the speedy progress of technology, vehicles are quite popularly to be installed with a back sensor or display unit to show the back side during driving or parking for providing the driver a better visual assistance and judgment to protect the car from any undesired damage or collision.

Nowadays, advanced vehicles are also provided with an Around-View Monitor (AVM), wherein the wide-angle cameras are established at different locations to collect full view images of 360-degree around the vehicle and to help or hint the driver to identify any potential obstacle. However, the existing AVM only displays the images taken by the cameras on a display screen and it does not provide a function of real-time recording of the image and/or does not allow those images to be downloaded for replaying the process or any investigation of fact related to the traffic accident which the driver involved in.

Thus, in view of the above problems, the present invention aims to provide a vehicular around-view driving monitor and recorder, which is capable of real-time storage, processing and algorithmic operation on around-view raw images to improve the safety of driver and to reduce the inconvenience occurred in a traffic accident and that of evidence investigation.

### SUMMARY OF THE INVENTION

The primary objective of the present invention is to provide a vehicular around-view driving monitor and recorder, which comprises a configuration of a plurality of wide-angle cameras, a real-time image monitoring and recording/playing unit, a visual image operation system, and a display device, wherein the visual image operation system comprises a raw image acquisition unit, a visual image processing unit, and a display processing unit, whereby the visual image operation system is able to carry out real-time processing and algorithmic operation on those raw images taken by the plurality of wide-angle cameras to enhance a safer driving environment, a correct and convenient visual driving assistance, and a real-time display of the around-view image.

Another objective of the present invention is to provide a vehicular around-view driving monitor and recorder, which comprises a real-time image monitoring and recording/playing unit to reserve the raw images taken by wide-angle cameras configured around the vehicle so as to allow genuine recovery of the true visual evidence without any illegal alteration and/or modification, and to provide an undoubted proof for investigation of any case which the driver is involved in.

A further objective of the present invention is to provide a vehicular around-view driving monitor and recorder, which performs a real-time visual processing including data correction toward the twisted raw images, images overlapping and a combination of algorithmic operation via the visual image operation system to convert those raw images shot from cameras into normal ones shown on the display and to fit the driver's visual practice and driving habit. And, that feature provides some visual effects for the driver to have a better spatial recognition and a more realistic distance ratio.

The present invention provides a vehicular around-view driving monitor and recorder, which comprises a plurality of wide-angle cameras, a real-time image monitoring and recording/playing unit, a visual image operation system, and a display device. The plurality of wide-angle cameras is configured around a vehicle to collect round-view raw images which cover certain angles of different directions around the said vehicle. The real-time image monitoring and recording/playing unit is connected to the plurality of wide-angle cameras for real-time storing of the round-view raw images shot by the wide-angle cameras. The visual image operation system is also connected to the said plurality of wide-angle cameras to obtain those raw images fed by the wide-angle cameras. The visual image operation system comprises a raw image acquisition unit, a visual image processing unit, and a display processing unit. The raw image acquisition unit collects and temporarily stores the raw images shot by the wide-angle cameras and is forward connected by the visual image processing unit which is then performing the function of real-time visual data processing and algorithmic operation including data correction toward the twisted raw images, image overlapping and a combination of algorithmic operation to convert those raw images into round-view ones shown on the display which fits the driver's visual practice and driving habit. Those processed visual images are then transmitted and integrated at the display processing unit to form as fully round-view images ready to be viewed on the display device. Finally, the display device, configured onboard the vehicle and connected to the display processing unit, presents the visual assistance and plays an important role of driving reference to provide a driver-friendly, correct and convenient configuration to enhance a better driving safety and reserve a recorded circumferential evidence during the driving process.

### BRIEF DESCRIPTION OF THE DRAWINGS

To enable a further understanding of the said objectives and the technological methods of the invention herein, the brief description of the drawings below is followed by the detailed description of the preferred embodiments.

FIG. 1 is a schematic block diagram of an embodiment according to the present invention; and

FIG. 2 is a schematic view shown by the display device to demonstrate an application of the present invention.

10—wide-angle camera

101—raw image
raw image shot from the front plate
raw image shot from the rear plate
raw image shot from the lower side of the left back mirror
raw image shot from the lower side of the right back mirror

20—real-time image monitoring and recording/playing unit

21—memory

22—transmission port

30—visual image operation system

31—raw image acquisition unit

32—visual image processing unit

321—visual image

33—display processing unit

40—display device

### DETAILED DESCRIPTION OF THE PREFERRED EMBODIMENTS

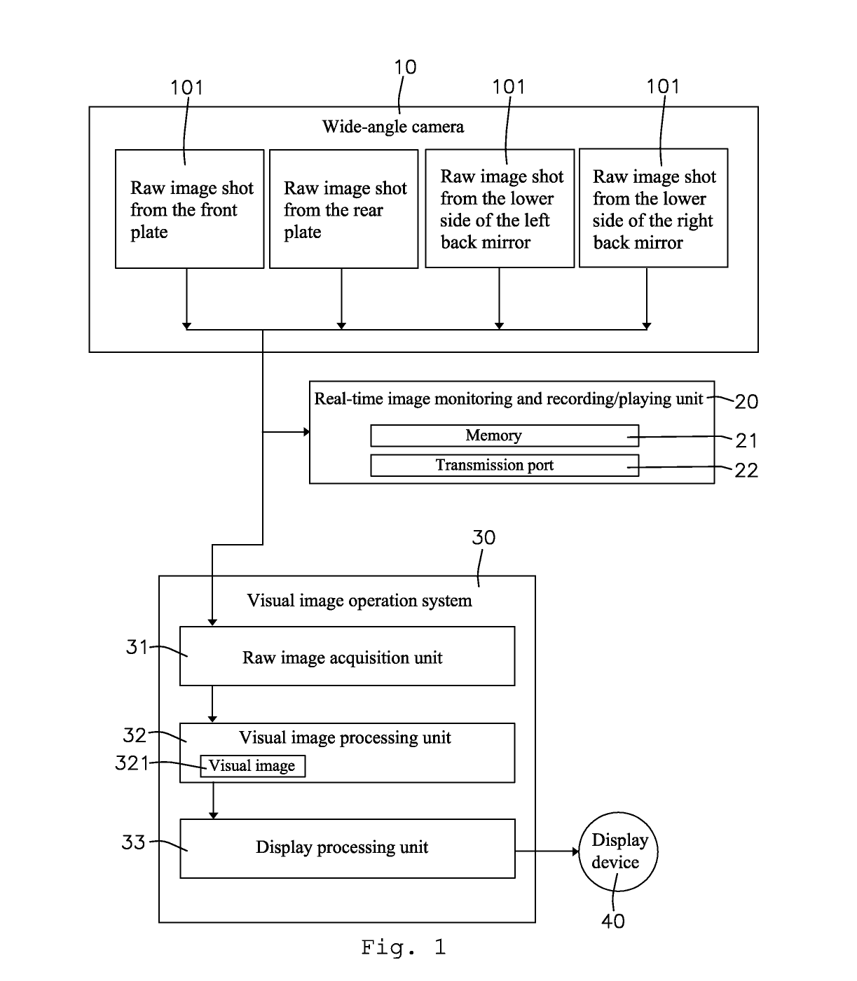

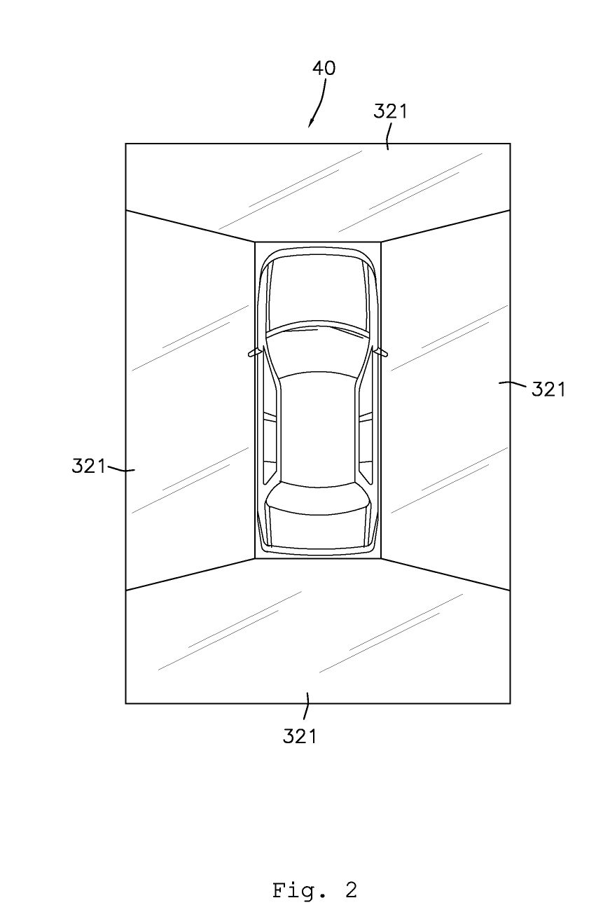

Please refer to FIGS. 1 and 2, which respectively shows a schematic block diagram of an embodiment and a schematic view shown by the display device to demonstrate an application of the present invention. The present invention provides a vehicular around-view driving monitor and recorder, which comprises a plurality of wide-angle cameras 10, an real-time image monitoring and recording/playing unit 20, a visual image operation system 30, and a display device 40. The plurality of wide-angle cameras 10 can take images in a range of round-view (namely 360 degrees) and is arranged at suitable locations around the structure of the vehicle to record the surrounding raw images 101. The real-time image monitoring and recording/playing unit 20 is connected to the plurality of wide-angle cameras 10 to receive and store the raw images 101 in a synchronous manner. The visual image operation system 30 also shares the same path connected to the plurality of wide-angle cameras 10 to synchronously receive the raw images 101. The visual image operation system 30 comprises a raw image acquisition unit 31, a visual image processing unit 32, and a display processing unit 33. The raw image acquisition unit 31 collects and temporarily stores the raw images 101 shot by the wide-angle cameras 10 and is further connected with the visual image processing unit 32 which performs a real-time visual processing related to the temporarily stored raw images 101 including data correction toward the twisted raw images, images overlapping and a combination of algorithmic operation to convert those raw images 101 shot from different located wide-angle cameras 10 into normal ones shown without any delay and to fit the driver's visual practice and driving habit. And, that feature provides some visual effects for the driver to have a better spatial recognition and a more realistic distance ratio. The converted visual image 321 is further transmitted to the display processing unit 33 which integrates those processed visual images to form as fully round-view images ready to be viewed on the display device 40. Eventually, the display device 40 presents the visual assistance and plays an important role of driving reference to provide a driver-friendly, correct and convenient configuration to enhance a better driving safety and reserve a recorded circumferential evidence during the driving process.

The real-time image monitoring and recording/playing unit 20 may further comprise a memory 21, which includes a hard disk drive and/or a memory card. The real-time image monitoring and recording/playing unit 20 may further comprise a transmission port 22, which allows output or downloading of raw image data for later official use. The transmission port 22 includes universal serial bus (USB), high speed serial bus (such as IEEE-1394), Integrated Device Electronics (IDE), Small Computer System Interface (SCSI), and Serial Advanced Technology Attachment (SATA). The raw image acquisition unit 31 comprises random access memory (RAM), for temporal storage of the raw images 101, which includes dynamic random access memory (DRAM) or static random access memory (SRAM). The visual image processing unit 32 provides real-time visual data processing including distortion correction, image overlapping, and a combination of algorithmic operations of the raw images 101 in order to convert the raw images suitable for driver's visual practice. The visual image can be displayed in a bird-view mode depending on the driver's need. The display device 40 can adopt an Around View Monitor (AVM).

Referring to FIGS. 1 and 2, which demonstrates a schematic block diagram and application of an embodiment according to the present invention and preferably comprises a number of wide-angle cameras 10, which are respectively mounted around the vehicle at sites close to both the front and the rear plates, and under each side of both back mirrors. Wide-angle cameras 10 may be additionally configured at any other suitable locations depends on the dimension of the vehicle. Further, the plurality of wide-angle cameras 10 are connected to the real-time image monitoring and recording/playing unit 20 which is provided with a memory 21 connected to store the raw images 101 synchronously. The real-time image monitoring and recording/playing unit 20 is also provided with a transmission port 22, for later output the storing raw images 101, which is ranging from USB, IEEE-1394, IDE, SCSI, or SATA. Thus, the raw images 101 stored in the memory 21 are not subject to any alteration, modification and/or any illegal use. The present invention provides an efficient and a trustable evidence for clarifying the traffic accident wherever or whenever the driver or the vehicle is involved in.

Therefore, the present invention is applicable to drivers' visual assistance, prevention of traffic accident and/or collision and the recovery of traffic evidence of various types of vehicles during the driving process.

What is claimed is:

1. A vehicular around-view driving monitor and recorder, comprising:
a plurality of wide-angle cameras, which are respectively mounted to locations around the structure of the vehicle to shoot the round-view raw images;
a real-time image monitoring and recording/playing unit, which is connected to a plurality of wide-angle cameras to synchronously receive and store the raw images;
a visual image operation system, connected to a plurality of wide-angle cameras to receive the raw images, is further comprising a raw image acquisition unit, a visual image processing unit, and a display processing unit, wherein the raw image acquisition unit synchronously receiving and temporarily storing the raw images from the wide-angle cameras and is forward connected with the visual image processing unit for further processing the temporarily stored raw images, and the visual image processing unit is forward connected with the display processing unit; and
a display device, connected to the display processing unit of the visual image operation system, which is configured onboard a vehicle to display the processed visual images from the visual image operation system.

2. A vehicular around-view driving monitor and recorder according to claim 1, wherein the plurality of wide-angle cameras realize an angular covering range of full view (360 degrees).

3. A vehicular around-view driving monitor and recorder according to claim 1, wherein the real-time image monitoring and recording/playing unit comprises a memory connected thereto, and the memory is a hard disk drive or a memory card.

4. A vehicular around-view driving monitor and recorder according to claim 1, wherein the real-time image monitoring and recording/playing unit comprises a transmission port for further output or downloading, the transmission port is one of universal serial bus, high speed serial bus, Integrated Device Electronics, Small Computer System Interface, or Serial Advanced Technology Attachment.

5. A vehicular around-view driving monitor and recorder according to claim 1, wherein the raw image acquisition unit comprises a random access memory which is a dynamic random access memory or a static random access memory.

6. A vehicular around-view driving monitor and recorder according to claim 1, wherein the real-time visual raw data processing and algorithmic operation of distortion correction, image overlapping, and a combination of the raw images conversion are carried out in the visual image processing unit.

7. A vehicular around-view driving monitor and recorder according to claim 1, wherein the visual image is displayed in a bird-view mode.

8. A vehicular around-view driving monitor and recorder according to claim 6, wherein the visual image is displayed in a bird-view mode.
